(19) United States
(12) Patent Application Publication
(10) Pub. No.: US 2004/0194073 A1
(43) Pub. Date: Sep. 30, 2004

(54) Optimization based on simulated linking

(76) Inventors: Sun C. Chan, Fremont, CA (US); Knud J. Kirkegaard, San Jose, CA (US); David C. Sehr, Cupertino, CA (US); Richard J. Tobacco, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/401,994

(22) Filed: Mar. 27, 2003

(51) Int. Cl. G06F 9/45; G06F 9/44

(52) U.S. Cl. 717/151; 717/162

(57) ABSTRACT

Identifying at least one unresolved symbol referenced in a first program component during a compilation phase of the first program component, searching a second program component that comprises object code, for a definition of the unresolved symbol, and selecting a type of compiler optimization for at least the first program component based at least in part on the results of the search of the second program component.

### BACKGROUND

Software engineers generally write software in human-readable source code that a compilation system then translates to executable object code. Compilation systems may assume many different forms, depending on the application. In a traditional development environment, a compiler may be a stand-alone program that takes a program component such as a source code file as input and produces an object code version of the component, for example the well-known gcc compiler. In other environments, a compilation system may be a part of a run-time environment that translates source code into executable code on the fly immediately prior to executing it. Such a compilation system may be termed an interpreter and is exemplified by the Perl system. In yet another instance, compilation systems may convert source program components into an intermediate format in one phase to provide advantages such as portability across multiple computing platforms. Another phase of the compilation system termed a virtual machine or run-time environment may then actually convert the intermediate format into executable code at runtime. Java compilation and virtual machines exemplify this type of compilation system.

In compilation systems, at least two phases may be identified in the process that generates object or intermediate code. First, a compilation phase translates separate program components or source code files into separate object or intermediate code files, and precedes a linking phase. The purpose of the linking phase is to resolve references made in each of the relevant program files to names or symbols defined in another program file, such as calls to external functions or references to externally defined objects, variable data, and data constants. The linking phase uses both the files produced by the compilation phase as well as existing, previously compiled files such as library files to locate definitions for unresolved symbols and to resolve them.

In one kind of linking termed static linking, the result of the compilation and linking of a complete and syntactically correct set of program files that include an execution entry point is an executable whole program, either in the form of object code or an intermediate code, which can be stored for later execution. A computer may then execute the whole program either directly or with the assistance of a virtual machine.

In other instances, a compilation system may produce a storable program that is not itself a whole program but is dynamically linkable to form an executable whole program with a set of library programs during and/or shortly before the time it is executed. A dynamic linker then forms a part of the run time environment for such a program. Such a linker then creates a whole program that is ephemeral, that is, it is not stored permanently but is created dynamically in a system memory for execution, at run time.

It is also possible for a compilation system to compile a set of source files that are not intended to form a whole program. This may occur in one instance during the creation of a library program that will provide functions to another main program but is not intended to be executed by itself. Such library programs typically are linked but lack an execution entry point and are therefore not whole programs.

Compiler optimization is a technique used to improve performance characteristics of all types of programs produced by a compilation system. In the compilation phase, the system may modify the code produced using a wide assortment of well-known optimization techniques to improve performance characteristics such as the speed of execution of the code or its memory usage, among others. In general, a compilation system can improve compiler optimization when additional information is available about the program and the processor based system that will execute the program. For example, if the compilation system is producing object code for a specific computer architecture it is often better able to optimize the object code than if it is producing intermediate code that is portable to a large number of different computer architectures.

Certain linking-related information about the program being compiled is also known to be useful for improved optimization. If a compilation system is able to determine in advance the degree to which the program being compiled will eventually approach a whole program, the system may be able improve its optimization of the program being compiled. The specific knowledge that the program being compiled, when linked, will form a whole program (termed “whole program detection”) is however, often unavailable at the compilation phase of the process. While approaches that perform whole program detection after the compilation phase in systems that produce intermediate code exist, these approaches can only perform optimizations in the runtime phase of converting the intermediate code into object code, and are of little use in general compilation systems that generate and use object code files.

### BRIEF DESCRIPTION OF THE DRAWINGS

FIG. 1 shows a generalized block diagram of one embodiment of the claimed subject matter.

FIG. 2 shows a flowchart depicting high level processing in one embodiment of the claimed subject matter.

### DETAILED DESCRIPTION

Some embodiments of the claimed subject matter are implemented as components of compilation systems. In one embodiment, such a compilation system is implemented as a standalone compiler program, such as the Intel® C++ compiler 7.0 for Windows™ and the Intel C++ compiler 7.0 for Linux. This type of system generally takes a set of C++source files, including references to object library files, as input and produces as output an executable object code file, or an library object code file. In other embodiments compilation systems may be similar to the Intel C++ compiler, but be provided for other programming languages, including for example, the Intel Fortran Compiler 7.0. The invention may also be implemented as a component of an integrated runtime environment for an interpreted language such as Perl, or as part of a virtual machine such as a Java virtual machine. In each of these cases, the system performs the same essential task—that of translating a human readable source code language program component into object code that may be executed on a processor based system. The claimed subject matter is, however, not restricted to these embodiments, rather, the subject matter is applicable to any system that translates any higher-level language version of a program into an object code version of a program. Thus, a system that translates non-human readable intermediate code such as Pascal p-code, Perl library code, or the Java “java” intermediate format into executable form may also implement an embodiment of the claimed subject matter.

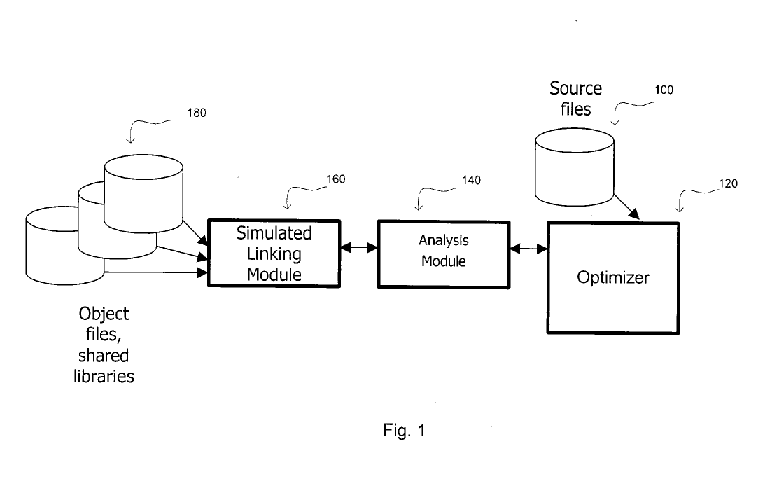

A general view of such an embodiment is provided in FIG. 1. During the compilation phase, program components provided as source files 100 are converted into optimized object files by the optimizing compilation system partially depicted in FIG. 1. To select the most appropriate type of compiler optimization for the source files, the system performs a simulated linking step using both the source files 100 and the relevant set of referenced program components—i.e. the object files and shared libraries 180, in the simulated link module 160. The link module attempts to resolve all unresolved symbols in source files 100 by searching the files 180 in a manner similar to that of a standard linker, well known in the compiler art. The key difference, however, is that this simulated linking process is being performed in the compilation phase of the compilation system in order to assist in selecting the type of compilation optimization for the code generated by the compilation phase in this embodiment of the invention, whereas, in the prior art, undefined symbols are resolved in the linking phase the follows the compilation phase to create the final executable or library version of the source files.

The analysis module 140 examines the results of the simulated linking done by the simulated linking module and evaluates whether all data symbols in the source files are resolvable, whether all non-data symbols in the source files are resolvable and whether an execution entry point will exist somewhere in the program component that will finally be produced by the compilation system. Based on the results of the analysis, the optimizer 120 then uses a particular type of compiler optimization for the source files to produce optimized object code.

It should be noted that the depiction in FIG. 1 is that of one embodiment of the claimed subject matter. In other embodiments, many variations are possible. These include embodiments where the program component being compiled such as the source, object code and library components are not “files” in the sense of disk resident files on a computer system. Rather, these components may in one embodiment reside in a system memory such as a flash memory or NVRAM; or alternatively, be available as data streamed over a data broadcast from a network. Furthermore, the modules in the figure are merely for illustrative purposes. Actual embodiments will vary in terms of the number and types of internal modules used to implement functionality in accordance with the claimed subject matter. The actual compilation system may be implemented for and executed on a wide variety of processor based systems such as a personal computer (PC), workstation, laptop computer, hand held computer or Personal Digital Assistant (PDA), for a few examples.

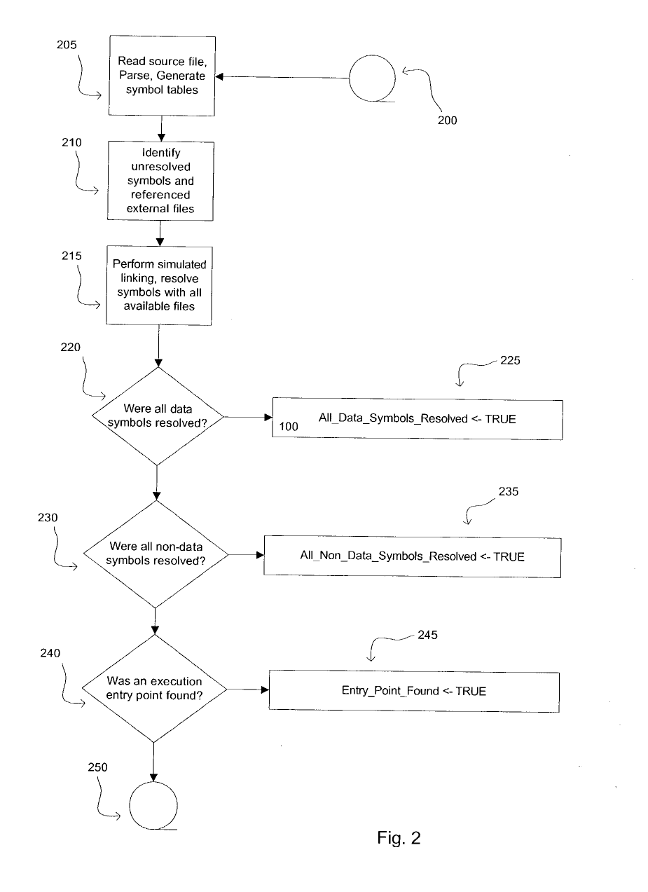

The selection of the type of compiler optimization may be understood with reference to FIG. 2. The figure shows a high level representation of aspects of the compilation system's operation related to the claimed subject matter. In a manner familiar to those in the compilation art, the system starting at 200, first reads and parses source files (such as those depicted at 100 in FIG. 1) and generates symbol tables, which are standard tasks at the front end of a compilation system, in step 205. In the next step 210, the system identifies unresolved symbols and the names of referenced external files or objects that may contain the definitions of the unresolved symbols. Using these unresolved symbols and the available files including the source files and the object files and libraries as depicted in FIG. 1 at 180, the system then performs simulated linking to determine the answers to three questions as depicted in FIG. 2. The first question is whether all data symbols are resolvable; the second is whether all non-data symbols (such as class names, function calls and procedure calls, among others) are resolvable; and the third is whether in all of the relevant files, an execution entry point exists. The output of these three parts of the analysis, depicted in the figure by the values of three abstract output variables

All_Data_Symbols_Resolved (225),

All_Non_Data_Symbols_Resolved (235) and Entry_Point_Found (245), then allows a decision to be made by the analysis module.

Depending on the actual results of analysis, different types of optimization may be chosen. One specific instance is the detection of a “whole program” by the analysis phase. This corresponds to all the three abstract variables being set to TRUE by the analysis process depicted in FIG. 2, that is a set of files where all undefined symbols are resolvable and an execution entry point has been found. In this situation, the optimizer in FIG. 1 may use a class of compiler optimizations termed “whole program optimizations” effectively at 120. Even if a whole program is not detected, other outputs of analysis such as a determination that all data symbols are resolvable (i.e. All_Data_Symbols_Resolved is TRUE), may allow the optimizer to select a better type of compiler optimization than is possible in the absence of the information from the simulated linking and analysis steps as in FIG. 2. Similarly, other sets of values for the three abstract output variables of FIG. 2 may allow the optimizer to select a potentially different type of compiler optimization for each set.

The process depicted in FIG. 2 is a high level depiction of one embodiment of the claimed subject matter. It should be clear to an artisan that a simulated linking phase such as the one described is capable of producing a substantial amount of information, far more than is depicted by the three variables shown in FIG. 2. This information may in many embodiments provide additional basis for tuning the optimizer module of the compilation system. For one example, if simulated linking shows that data symbols remain unresolved, the data sizes and types of unresolved symbols may be relevant to selecting the type of compiler optimization. Furthermore, the actual steps shown in FIG. 2 are not representative of the actual structure of the implementation of any embodiment but are meant to teach the claimed subject matter and are simplified and presented at a high level for purposes of exposition.

Reference throughout this specification to “one embodiment” or “an embodiment” means that a particular feature, structure or characteristic described in connection with the embodiment is included in at least one embodiment of the claimed subject matter. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments

Embodiments of the claimed subject matter include various steps. These steps may be performed by hardware components, or may be embodied in machine-executable instructions, which may be used to cause a general-purpose or special-purpose processor or logic circuits programmed with the instructions to perform the steps. Alternatively, the steps may be performed by a combination of hardware and software. An embodiment of the claimed subject matter may be provided as a computer program product or as part of the Basic Input/Output System (BIOS) of a computer that may include a machine-readable medium having stored thereon data which when accessed by a machine may cause the machine to perform a process of the claimed subject matter. The machine-readable medium may include, but is not limited to, floppy diskettes, optical disks, DVD-ROM disks, DVD-RAM disks, DVD−RW disks, DVD+RW disks, CD-R disks, CD-RW disks, CD-ROM disks, and magneto-optical disks, ROMs, RAMs, EPROMs, EEPROMs, magnet or optical cards, flash memory, or other type of media/machine-readable media suitable for storing electronic instructions. Moreover, an embodiment of the claimed subject matter may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form but steps can be added to or deleted from any of the methods and information can be added or subtracted from any of the described messages without departing from the basic scope of the claims. It will be apparent to those skilled in the art that many further modifications and adaptations can be made. The particular embodiments of the claimed subject matter are not provided to limit the claims but to illustrate it. The scope of the claims is not to be determined by the specific examples provided above but only by the claims themselves as provided below.

What is claimed is:

1. A method comprising:
identifying at least one unresolved symbol referenced in a first program component during a compilation phase of the first program component;
searching a second program component that comprises object code, for a definition of the unresolved symbol; and
selecting a type of compiler optimization for at least the first program component based at least in part on the results of the search of the second program component.

2. The method of claim 1 further comprising:
simulating linking of the first program component by
identifying all other available program components directly or indirectly referenced by the first program component (“the referenced program components”); and
resolving all symbols referenced in the first program component that may be resolved by analysis of the referenced program components;
analyzing the result of simulated linking to determine the symbols that remain unresolved, if any; and
selecting a type of compiler optimization for at least the first program component depending on the symbols that remain unresolved by simulated linking.

3. The method of claim 2 further comprising selecting a first type of compiler optimization for at least the first program component if only non-data symbols remain unresolved by simulated linking.

4. The method of claim 2 further comprising selecting a second type of compiler optimization if both data and non-data symbols remain unresolved by simulated linking.

5. The method of claim 2 further comprising:
searching for an execution entry point in the first program component and the referenced program components (“all the program components”); and
selecting a third type of compiler optimization based on whole program detection for at least the first program component if an execution entry point is located in one of all the program components and if no symbols remain unresolved by simulated linking

6. The method of claim 5 wherein the first program component comprises C++ source code.

7. The method of claim 5 wherein the first program component comprises Java source code.

8. The method of claim 5 wherein the first program component comprises C source code.

9. The method of claim 5 wherein the first program component comprises Fortran source code.

10. The method of claim 5 further comprising compiling the first program component into object code that is executable on an Intel Architecture processor.

11. A method comprising:
during a compilation phase of a first program component, analyzing all other available program components directly or indirectly referenced by the first program component, at least one of which comprises object code, (“the referenced program components”) by simulating linking of the first program component; and
if no symbols remain unresolved following simulating linking of the first program component and if an execution entry point is found in the first program component or in any of the referenced program components, then
selecting a type of compiler optimization based on whole program detection for at least the first program component.

12. A compilation system comprising:
a compilation module to compile a first program component;
a simulated linking module to simulate linking of the first program component with a second program component, the second program component comprising object code, during a compilation phase of the first program component and to determine whether an execution entry point is located in either the first or in the second program component;
an analysis module to select a type of compiler optimization for the compilation component based on the outputs of the simulated linking component and the entry point detection component.

13. A compilation system comprising:
a compilation module to compile a first program component;
a simulated linking module
to identify all other available program components directly or indirectly referenced by the first program component (“the referenced program components”);
to resolve all symbols referenced in the first program component that may be resolved by analysis of the referenced program components;
to analyze the result of simulated linking to determine the symbols that remain unresolved, if any; and
to determine whether an execution entry point is located in one of the first program component and the referenced program components (“all the program components”);
an analysis module to select a type of compiler optimization for the compilation module depending on the outputs of the simulated linking module.

14. The compilation system of claim 13 wherein the analysis module is further to select a type of whole program compiler optimization for the compilation module if the simulated linking module detects no unresolved symbols and detects an execution entry point in one of all the program components.

15. A compilation system comprising:
a compilation module to compile a first program component;
a simulated linking module to simulate linking of the first program component with a second program component, the second program component comprising object code, during a compilation phase of the first program component and to determine whether an execution entry point is located in either the first or in the second program component;
an analysis module to select a type of compiler optimization for the compilation component based on the outputs of the simulated linking component and the entry point detection component; and
a code generation component to generate code that is executable on an Intel® Architecture processor.

16. A machine readable medium having stored thereon data that when accessed by a machine causes the machine to perform the method of claim 1.

17. The machine readable medium of claim 13 having stored thereon further data that when accessed by the machine causes the machine to perform the method of claim 2.

18. The machine readable medium of claim 14 having stored thereon further data that when accessed by the machine causes the machine to perform the method of claim 3.

19. The machine readable medium of claim 14 having stored thereon further data that when accessed by the machine causes the ma chine to perform the method of claim 4.

20. The machine readable medium of claim 16 having stored thereon further data that when accessed by the machine causes the machine to perform the method of claim 5.

21. The machine readable medium of claim 17 having stored thereon further data that when accessed by the machine causes the machine to perform the method of claim 6.

22. The machine readable medium of claim 17 having stored thereon further data that when accessed by the machine causes the machine to perform the method of claim 7.

23. The machine readable medium of claim 17 having stored thereon further data that when accessed by the machine causes the machine to perform the method of claim 8.

24. The machine readable medium of claim 17 having stored thereon further data that when accessed by the machine causes the machine to perform the method of claim 9.

25. The machine readable medium of claim 17 having stored thereon further data that when accessed by the machine causes the machine to perform the method of claim 10.

26. A machine readable medium having stored thereon data that when accessed by a machine causes the machine to perform the method of claim 11.
